(19) United States
(12) Patent Application Publication
(10) Pub. No.: US 2018/0341652 A1
(43) Pub. Date: Nov. 29, 2018

(54) INFORMATION PRESENTATION METHOD, INFORMATION PRESENTATION PROGRAM, AND INFORMATION PRESENTATION APPARATUS

(71) Applicant: FUJIFILM Corporation, Tokyo (JP)

(72) Inventor: Kei YAMAJI, Tokyo (JP)

(73) Assignee: FUJIFILM Corporation, Tokyo (JP)

(21) Appl. No.: 16/052,165

(22) Filed: Aug. 1, 2018

Related U.S. Application Data
(63) Continuation of application No. PCT/JP2017/001291, filed on Jan. 17, 2017.

(30) Foreign Application Priority Data
Mar. 10, 2016 (JP) 2016-046768

(51) Int. Cl. G06F 17/30; G06K 9/00

(52) U.S. Cl. CPC G06F 17/30032; G06F 17/30241; G06F 17/30616; G06K 9/00335

(57) ABSTRACT

Provided are an information presentation method, an information presentation program, and an information presentation apparatus capable of causing users to easily share useful information. In the information presentation method, the information presentation program, and the information presentation apparatus according to an aspect of the invention, since the degree of association is calculated on the basis of behavior information and processes from requesting behavior information to presenting the behavior information are performed on the basis of the degree of association, users can save labor for setting a degree of association in person, and can easily share the behavior information. Further, even in a case where a partner who shares the behavior information is not only a close person or an acquaintance but also a person who is a stranger having a common behavior or preference, it is possible to share the behavior information. Accordingly, users can easily share useful information.

### CROSS REFERENCE TO RELATED APPLICATIONS

This application is a Continuation of PCT International Application No. PCT/JP2017/001291 filed on Jan. 17, 2017, which claims priority under 35 U.S.C § 119(a) to Patent Application No. 2016-046768 filed in Japan on Mar. 10, 2016, all of which are hereby expressly incorporated by reference into the present application.

### BACKGROUND OF THE INVENTION

### 1. Field of the Invention

The present invention relates to an information presentation method, a non-transitory computer readable recording medium storing an information presentation program, and an information presentation apparatus, and particularly, to an information presentation method, a non-transitory computer readable recording medium storing an information presentation program, and an information presentation apparatus that present a user with information on behaviors of other users.

### 2. Description of the Related Art

In a portable terminal such as a smartphone or a tablet terminal, it is possible to acquire a variety of information such as time information, position information, and images. Further, in recent years, it is possible to acquire biological information on a user using a wearable terminal that is worn on the body of the user. Further, a technique for sharing information acquired by such a terminal device between a plurality of users is known. For example, JP2010-134802A discloses a technique for detecting a user's behavior using various sensors to calculate behavior parameters and displaying an object based on a state of a user, and a technique for calculating the degree of intimacy between users according to the number of phone calls or durations of calls. Further, JP2009-187233A discloses a technique for transmitting, to a user who is a requestor, photos imaged by other users, and a technique for using information such as the degree of intimacy as a photo selection determination factor.

### SUMMARY OF THE INVENTION

In a case where information is shared between users and the information is shared between a large number of unspecified users without limiting users, the amount of information to be shared becomes excessively large. On the other hand, in a case where information is shared only between a user and users who are registered as information sharing partners by the user, information to be shared is limited. In addition, since information that is merely shared is less valuable for users, it is desirable to share information valuable for users, such as behaviors or preferences of the users.

With respect to such a problem, in JP2010-134802A, the degree of intimacy between users is used for arrangement of objects on a screen, but is not utilized for information sharing. In JP2009-187233A, it takes labor for a user to report the degree of intimacy since the user reports the degree of intimacy in person, and thus, a range of users who share information is limited to close persons or acquaintances. Thus, it is difficult to share information with strangers having common behaviors or preferences. As described above, in the related art, users cannot easily share useful information.

The invention has been made in consideration of the above-described problem, and an object of the invention is to provide an information presentation method, an information presentation program, and an information presentation apparatus capable of causing users to easily share useful information.

In order to achieve the above-mentioned object, according to a first aspect of the invention, there is provided an information presentation method using a computer comprising: a behavior information acquisition process of acquiring behavior information of users; an association degree calculation process of calculating, on the basis of the behavior information of a first user and the behavior information of a different user, a degree of association between the first user and the different user; an acquisition request reception process of receiving an acquisition request of the behavior information with respect to the different user from the first user; a request information determination process of determining information to be requested with respect to the different user from the first user, on the basis of the behavior information of the first user at a time when the acquisition request is received; an information request process of requesting the behavior information with respect to the different user from the first user, the information request process requesting the determined behavior information according to the calculated degree of association; and an information presentation process of presenting the behavior information of the different user that is acquired according to the request to the first user.

In the information presentation method using the computer according to the first aspect of the invention, since the degree of association is calculated on the basis of behavior information, it is possible to save user's labor for setting the degree of association in person. Further, since the behavior information request is performed according to the degree of association, partners who share information are not limited to close persons or acquaintances, and it is possible to share information with strangers having common behaviors or preferences. Thus, in the information presentation method according to the first aspect of the invention, users can easily share useful information.

In the first aspect of the invention, it is assumed that the “behavior information of the first user “at a time when” the acquisition request is received” includes a case where a timing when the acquisition request is received and a timing when the behavior information of the first user is acquired do not completely match each other. That is, the timing when the acquisition request is received and the timing when the behavior information of the first user is acquired may deviate from each other in a range where there is no influence on content of the behavior information (a range where a temporal change of the behavior information is allowable in view of properties of the information).

In the first aspect of the invention, the “request according to the degree of association” includes a case where information request is preferentially given to a user having a high degree of association in behavior information. Further, in the first aspect of the invention, “the first user” and “the different user” may be any users, and the same user may be an information requestor and an information provider.

Further, the respective processes of the information presentation method according to the first aspect of the invention may be executed by a server and/or a user terminal in an information presentation apparatus (system) in which the user terminal and the server are connected to each other through a network. One of the server and the user terminal may execute all the processes, or each one may execute a part of the processes so that all the processes are executed as a whole.

According to a second aspect of the invention, in the information presentation method using the computer according to the first aspect of the invention, in the request information determination process, the behavior information to be requested with respect to the different user is determined with reference to a relationship between the behavior information of the first user at the time when the acquisition request is received and the behavior information to be requested with respect to the different user, which is stored in advance. The second aspect of the invention has a configuration for specifying how to determine behavior information to be requested with respect to the different user.

According to a third aspect of the invention, in the information presentation method using the computer according to the first or second aspect of the invention, in the association degree calculation process, the degree of association is calculated according to a commonality of the behavior information. For example, as the commonality of the behavior information becomes higher, the degree of association may be calculated to become higher.

According to a fourth aspect of the invention, in the information presentation method using the computer according to any one of the first to third aspects of the invention, in the association degree calculation process, a weight for a commonality of specific information among information included in the behavior information is set to be higher than a weight for a commonality of different information to calculate the degree of association. Thus, it is possible to appropriately calculate the degree of association.

According to a fifth aspect of the invention, the information presentation method using the computer according to any one of the first to fourth aspects of the invention further comprises: an information transmission process of presenting the behavior information of the first user to the different user according to an information acquisition request from the different user. The fifth aspect of the invention has a configuration for further clarifying that the behavior information of the first user is presented to the different user, that is, that the behavior information is bi-directionally shared between users.

According to a sixth aspect of the invention, in the information presentation method using the computer according to the fifth aspect of the invention, in the information transmission process, the behavior information of the first user corresponding to the behavior information of the different user presented to the first user is presented to the different user. The sixth aspect of the invention shows a relationship between the behavior information presented to the first user and the behavior information to be presented to the different user. Here, “the behavior information of the first user corresponding to the behavior information of the different user is presented (to the different user)” includes a case where the behavior information of the first user for the same period of time when the behavior information is presented to the first user is presented to the different user, and a case where behavior information of the same type or classification as that of the behavior information (of the different user) presented to the first user or behavior information related thereto is presented to the different user.

According to a seventh aspect of the invention, in the information presentation method using the computer according to any one of the first to sixth aspects of the invention, the behavior information includes first information that is information acquired by association of one type of information and a different type of information that are two or more types of information among time information, position information, biological information, and imaging information of the users. The seventh aspect of the invention shows specific content of the behavior information, in which the “association” means that conditions that the behavior information is acquired are associated with each other, such as “a certain point in time and a position at the point in time”.

According to an eighth aspect of the invention, in the information presentation method using the computer according to any one of the first to seventh aspects of the invention, in the request information determination process, the information to be requested with respect to the different user is determined on the basis of second information that is information acquired by association of one type of information and a different type of information that are two or more types of information among time information, position information, and biological information of the users.

According to a ninth aspect of the invention, in the information presentation method using the computer according to any one of the first to eighth aspects of the invention, in the information presentation process, a plurality of types of information selected from time information, position information, biological information and imaging information of the users are presented in association. According to the ninth aspect of the invention, users can easily detect the relationship between the behavior information. The “plurality of types of information are presented in association” includes a case where “a certain point in time (time information) and a position at the point in time (position information) are presented” or a case where “biological information at a certain location (position information) is presented”, for example, but a form in which the plurality of types of information are presented in association is not limited to the above-described cases.

In order to achieve the above-mentioned object, according to a tenth aspect of the invention, there is provided an information presentation program causing an information presentation apparatus to execute the information presentation method according to any one of the first to ninth aspects of the invention. According to the information presentation program according to the tenth aspect of the invention, similarly to the first aspect of the invention, users can easily share useful information.

A non-transitory computer readable recording medium on which computer-readable codes of the information presentation program according to the tenth aspect are recorded may also be provided as an aspect of the invention. As an example of the non-transitory recording medium, an optical disc such as a compact disc (CD) or a digital versatile disc (DVD), a magnetic recording device such as a hard disk (HD), and various semiconductor recording mediums may be used, but the invention is not limited thereto.

In order to achieve the above-mentioned object, according to an eleventh aspect of the invention, there is provided an information presentation apparatus comprising: a behavior information acquisition section that acquires behavior information of users; an association degree calculation section that calculates, on the basis of the behavior information of a first user and the behavior information of a different user, a degree of association between the first user and the different user; an acquisition request reception section that receives an acquisition request of the behavior information with respect to the different user from the first user; a request information determination section that determines information to be requested with respect to the different user from the first user, on the basis of the behavior information of the first user at a time when the acquisition request is received; an information request section that requests the behavior information with respect to the different user from the first user, the information request section requesting the determined behavior information according to the calculated degree of association; and an information presentation section that presents the behavior information of the different user that is acquired according to the request to the first user. According to the information presentation apparatus according to the eleventh aspect, similarly to the first aspect of the invention, users can easily share useful information.

According to a twelfth aspect of the invention, the information presentation apparatus according to the eleventh aspect of the invention further comprises: a relationship storage section in which a relationship between the behavior information of the first user at a time when the acquisition request is received and the behavior information to be requested with respect to the different user is stored in advance, in which the request information determination section determines the behavior information to be requested with respect to the different user with reference to the stored relationship. The twelfth aspect of the invention has a configuration for specifying how to determine behavior information to be requested with respect to the different user, similarly to the second aspect of the invention.

According to a thirteenth aspect of the invention, the information presentation apparatus according to the eleventh or twelfth aspect of the invention further comprises: an information transmission section that presents the behavior information of the first user to the different user according to the information acquisition request from the different user. The thirteenth aspect has a configuration for further clarifying that behavior information is bi-directionally shared between users, similarly to the fifth aspect of the invention.

According to a fourteenth aspect of the invention, in the information presentation apparatus according to the thirteenth aspect of the invention, the information transmission section presents the behavior information of the first user corresponding to the behavior information of the different user presented to the first user to the different user. The fourteenth aspect of the invention shows a relationship between behavior information presented to the first user and behavior information to be presented to the different user, similar way to the sixth aspect of the invention.

As described above, according to the information presentation method, the information presentation program, and the information presentation apparatus of the invention, users can easily share useful information.

### BRIEF DESCRIPTION OF THE DRAWINGS

FIG. 1 is a diagram showing a configuration of an information presentation system according to an embodiment of the invention.

FIG. 2 is a diagram showing a configuration of a server.

FIG. 3 is a diagram showing a configuration of a user terminal.

FIG. 4 is a flowchart showing a processing procedure of an information presentation method.

FIG. 5 is a flowchart (subsequent to FIG. 4) showing the processing procedure of the information presentation method.

FIG. 6 is a table showing classification of users based on behavior information and examples of the degree of association with respect to the classification.

FIG. 7 is a diagram for illustrating a relationship between a timing when an acquisition request is received and a timing when user's behavior information is acquired.

FIG. 8 is a table showing an example of the user's behavior information.

FIG. 9 is a table showing behavior patterns and registration information.

FIG. 10 is a table showing the degree of association between users.

FIG. 11 is a table showing facility information.

FIG. 12 is a table showing a relationship between a user's mode and acquisition request information.

FIG. 13 is a table showing another example of the user's behavior information.

FIG. 14 is a diagram showing an example of information to be presented to a user.

FIG. 15 is a diagram showing another example of information to be presented to the user.

FIG. 16 is a diagram showing an example of an image to be presented to the user.

FIG. 17 is a diagram showing another example of an image to be presented to the user.

FIG. 18 is a diagram showing a still another example of information to be presented to the user.

FIG. 19 is a diagram showing a still another example of information to be presented to the user.

### DESCRIPTION OF THE PREFERRED EMBODIMENTS

Hereinafter, embodiments of an information presentation method, an information presentation program, and an information presentation apparatus according to the invention will be described with reference to the accompanying drawings.

<Configuration of System>

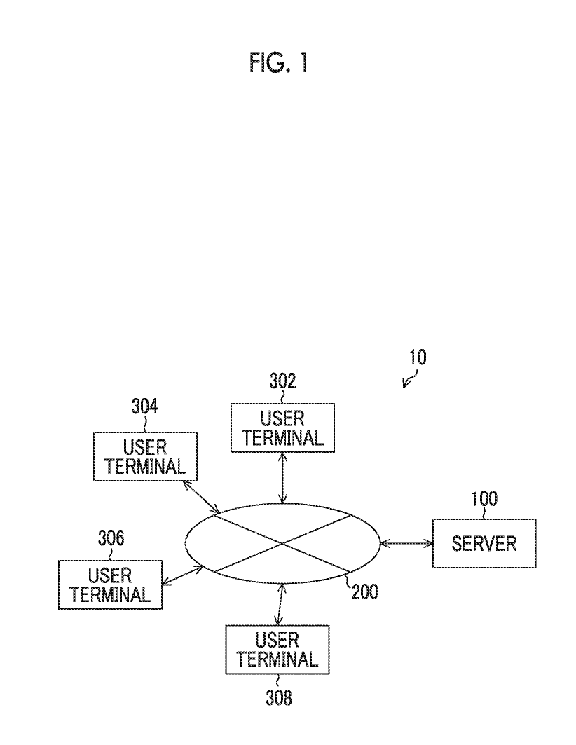

FIG. 1 is a diagram showing a configuration of an information presentation system 10 (an information presentation apparatus, a behavior information acquisition section, an association degree calculation section, an acquisition request reception section, a request information determination section, an information request section, an information presentation section, and information transmission section) according to an embodiment of the invention. The information presentation system 10 has a configuration in which multiple user terminals are connected to a server 100 through a network 200. The server 100 is provided by a service provider. The network 200 may be a general-purpose network such as the Internet, or may be an exclusive network of the information presentation system 10. Further, a network for a mobile phone or a smartphone may be used.

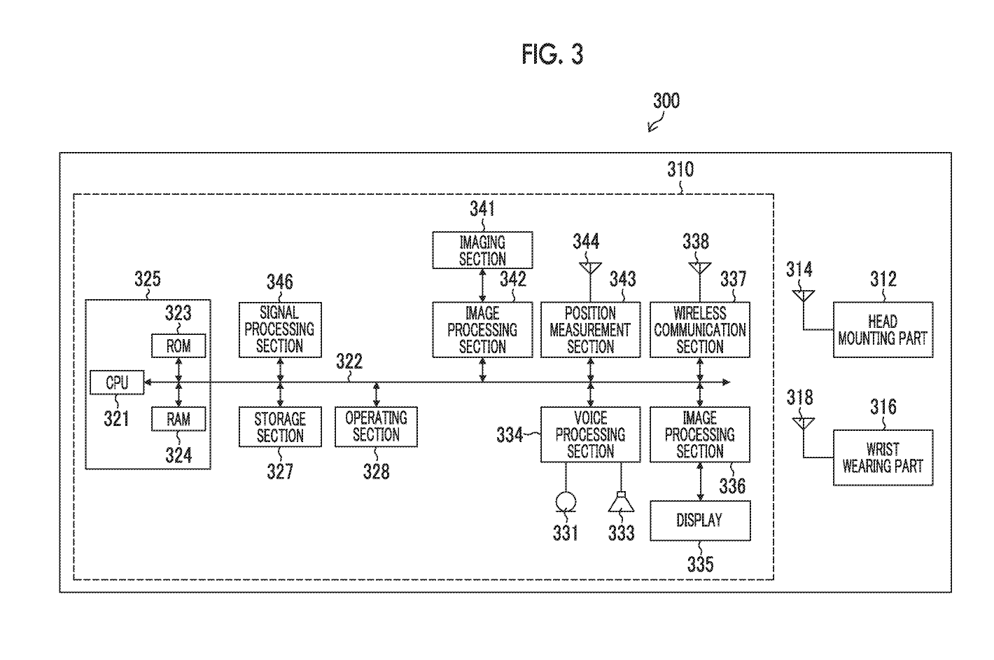

User terminals 302, 304, 306, and 308 (the behavior information acquisition section, the information presentation section, and the information transmission section) are portable terminals including, for example, a terminal body, a wrist wearing part, a head mounting part (see FIG. 3), and are used for acquisition or presentation of behavior information. In FIG. 1, for ease of description, four user terminals are shown, but in reality, multiple user terminals that use the information presentation system 10 may be present.

<Configuration of Server>

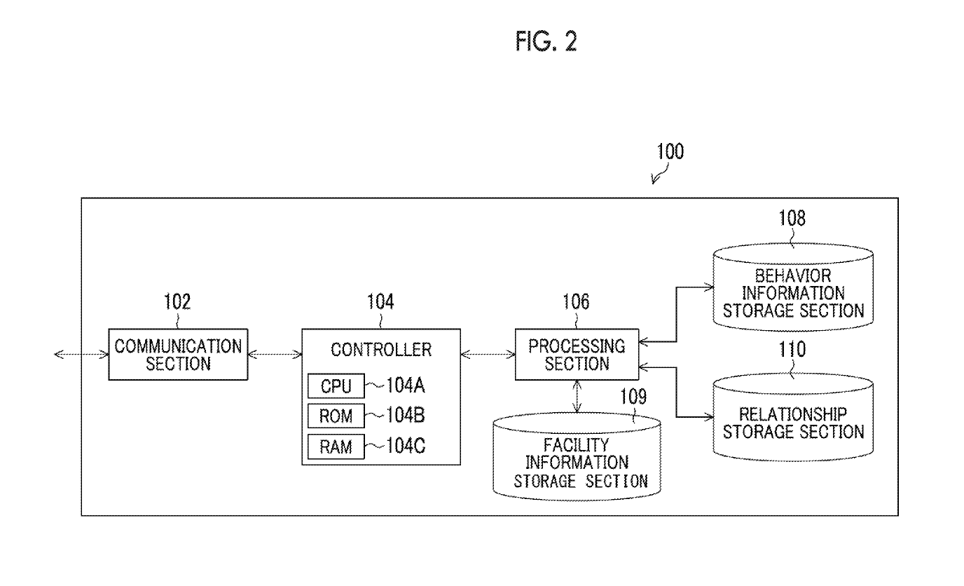

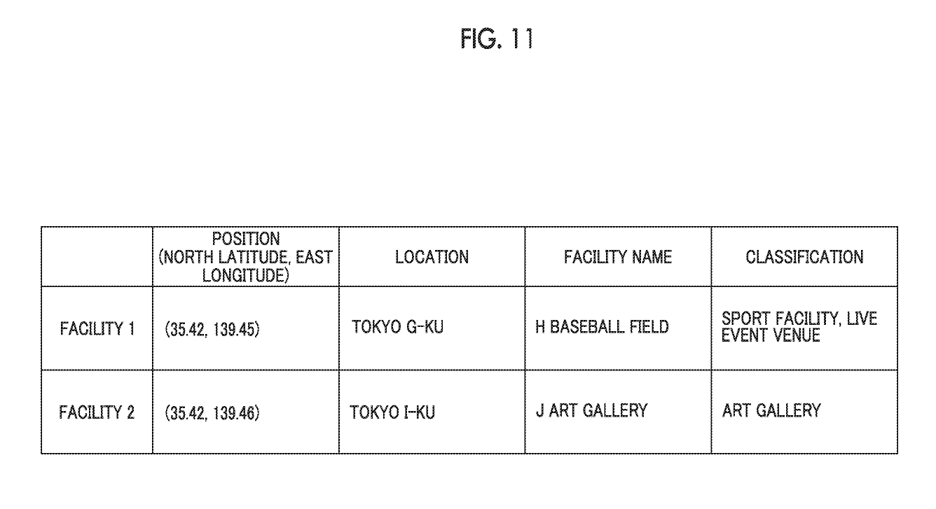

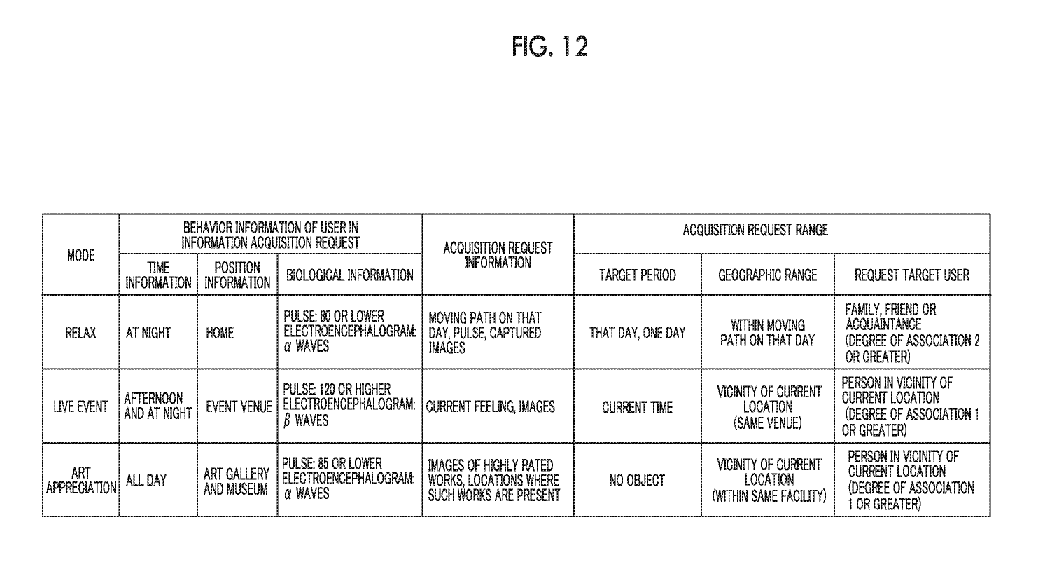

FIG. 2 shows a configuration of the server 100. In this embodiment, the server 100 includes a communication section 102, a controller 104, a processing section 106, a behavior information storage section 108, a facility information storage section 109, and a relationship storage section 110 (relationship storage section). The behavior information storage section 108 stores behavior information acquired from each user terminal, and the facility information storage section 109 stores information on positions of a variety of facilities, names of the facilities, classification thereof, and the like (see FIG. 11). The relationship storage section 110 stores a relationship (see FIG. 12) between user's situations and behavior information to be requested with respect to other users. The communication section 102 is connected to the above-mentioned network 200 to transmit or receive information with respect to respective user terminals. The controller 104 controls the entirety of the server 100. The processing section 106 performs input or output with respect to the behavior information storage section 108 and the relationship storage section 110 under the control of the controller 104, and performs processes such as analysis of behavior patterns of users, calculation of the degree of association, extraction of associated users, or acquisition and presentation of behavior information, using the information stored in the storage sections.

The respective sections of the above-mentioned server 100 are configured of devices such as a variety of signal processing circuits, in addition to a central processing unit (CPU) 104A, a read only memory (ROM) 104B, and a random access memory (RAM) 104C that are included in the controller 104. The ROM 104B is an example of a non-transitory recording medium on which computer-readable codes of the information presentation program according to this embodiment are recorded. Further, among the respective sections of the server, the behavior information storage section 108, the facility information storage section 109, and the relationship storage section 110 are configured to include a hard disk (HD) or a storage device such as a variety of semiconductor memories.

<Configuration of User Terminal>

FIG. 3 is a diagram showing a configuration of a user terminal 300 that is an exemplary user terminal. The user terminal 300 includes a terminal body 310, a wrist wearing part 316, and a head mounting part 312. The terminal body 310 is used for a user's operation or display of behavior information. Further, the terminal body 310 acquires biological information from the wrist wearing part 316 and the head mounting part 312 using near field wireless communication, and transmits the biological information to the server 100 through the network 200.

<Terminal Body>

The terminal body 310 may be configured of a smartphone-type portable terminal, for example, and includes a controller 325 that has a central processing unit (CPU) 321, a read only memory (ROM) 323, and a random access memory (RAM) 324. The ROM 323 (non-transitory recording medium) stores computer-readable codes of the information presentation program for executing the information presentation method according to this embodiment and a variety of data. The RAM 324 is used as a temporal work area of the program and data. Respective components of the terminal body 310 are connected to each other through a bus 322.

A storage section 327 includes a card-type recording medium that is detachably mounted with respect to the terminal body 310 or a semiconductor memory, and a user may perform reading and writing of behavior information of captured images or the like through the device. An operating section 328 is configured of a variety of buttons (keys), dials, or the like, and a user may perform operations such as inputting of behavior information or registration through the operating section 328. A display 335 is configured of a touch panel. A user's operation may be received through the touch panel.

A microphone 331 and a speaker 333 are used for voice communication, music generation, or the like through a voice processing section 334. The voice processing section 334 performs conversion between an analog voice signal and a digital voice signal, a compression process, and a decompression process, with respect to signals that are input to or output from the microphone 331 and the speaker 333.

An image processing section 336 is connected to the display 335. The display 335 is configured of a device such as a liquid crystal display or an organic electroluminescence (EL) display, and the image processing section 336 processes data on an image or a screen displayed on the display 335, and converts the processed data into a display drive analog signal. A wireless communication section 337 is connected to an antenna 338, and is used in voice communication or in connection to the server 100 through the network 200. Further, an imaging section 341 is connected to an image processing section 342. The imaging section 341 includes an imaging lens (not shown) and a solid-state image pickup element such as a charge coupled device (CCD) imaging element or a complementary metal-oxide semiconductor (CMOS) imaging element (not shown), and a user may capture an image of a desired subject using the imaging section 341 and the image processing section 342. A position measurement section 343 has a position measurement function (latitude, longitude, and altitude) based on a global positioning system (GPS), and is connected to an antenna 344 that receives signal radio waves from a GPS satellite.

With respect to the user terminals 302, 304, 306, and 308 of users 1 to 4 (which will be described later), the same configuration as that of the above-mentioned user terminal 300 may be employed. In the following description, in a case where components of the user terminals 302, 304, 306, and 308 are mentioned, reference numerals (see FIG. 3) assigned to the components of the user terminal 300 are used.

<Wrist Wearing Part and Head Mounting Part>

The wrist wearing part 316 is configured as a time-piece terminal mounted on the wrist of a user, for example. The wrist wearing part 316 acquires data on pulse of a user, and transmits the acquired pulse data to the terminal body 310 through near field wireless communication, through the antenna 318. The head mounting part 312 may be configured as a terminal of a hair band type, a glasses type, a cap type, or a head phone type, for example, and is mounted in a head part of the user. The head mounting part 312 acquires data on user's electroencephalogram, and transmits the result to the terminal body 310 through near field wireless communication, through the antenna 314.

<Information Presentation Process>

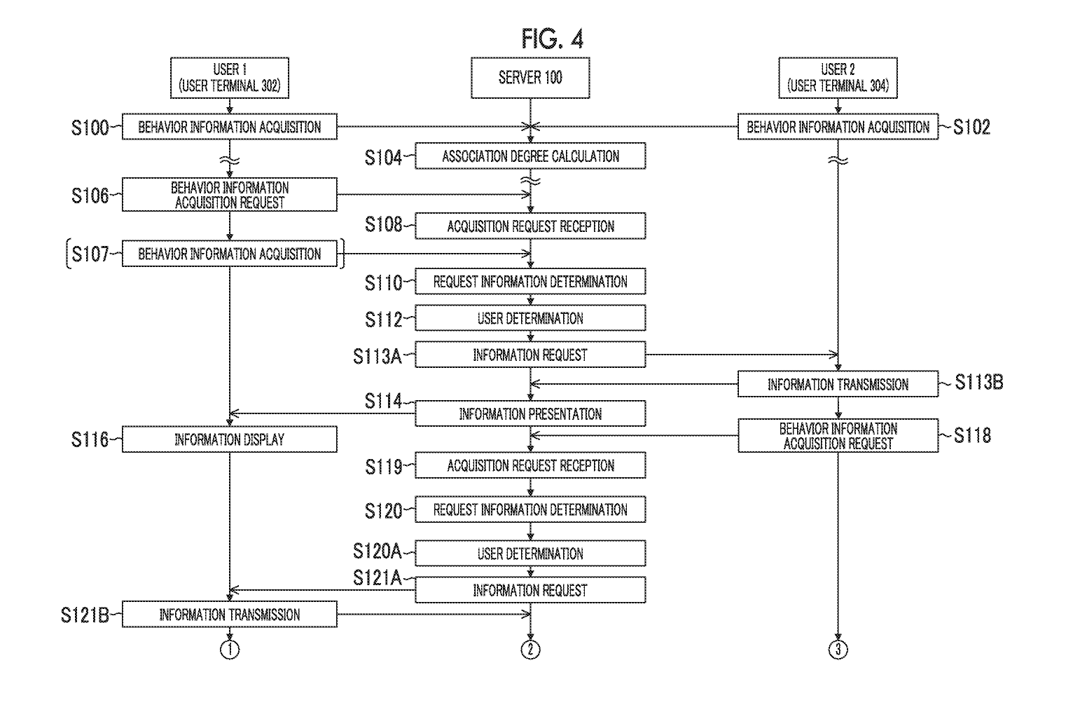

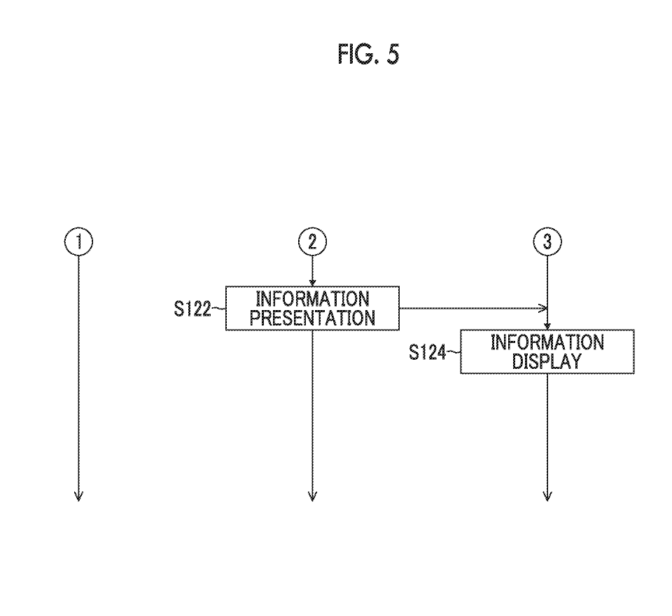

Next, a processing procedure of the information presentation method (information presentation program) in the information presentation system 10 according to this embodiment will be described. First, an outline of the processing procedure of the information presentation method (information presentation program) will be described with reference to FIGS. 4 and 5. Examples (cases 1 to 3) in which this processing procedure is applied to a specific situation will be described later. In the examples of FIGS. 4 and 5, for ease of description, processes in a case where two users are present are shown, but the number of users is not particularly limited in the invention.

First, the server 100 acquires behavior information of the user 1 (assumed as the user terminal 302 in FIG. 1: a first user) and the user 2 (assumed as the user terminal 304: a different user), and stores the result in the behavior information storage section 108 (steps S100 and S102: behavior information acquisition process). A period of time when the behavior information is acquired is not particularly limited, but in order to analyze routine and unusual behavior patterns, it is preferable to acquire behavior information during a considerable period of time (for example, one month or longer). Further, it is preferable to periodically acquire, accumulate, and update the behavior information. The server 100 calculates the degree of association between users from the acquired behavior information (step S104: association degree calculation process).

<Behavior Information and Association Degree>

Here, behavior information of users and the degree of association between the users based on the behavior information will be described. The behavior information generally refers to information acquired in association with behaviors of users, and for example, may include time information, position information, biological information, registration information, and imaging information. The time information represents, for example, a specific point in time, a specific time slot, or a set thereof. The position information may include a geographic name, a regional name, a country name, a facility name, a store name, or the like, in addition to latitude, longitude, and altitude. The biological information may include pulse, an electroencephalogram, blood pressure, sweating, or the like. The registration information refers to information relating to an address, a name, an age, an occupation, a family structure, a hobby, and the like that are registered by a user. The imaging information refers to images captured by a user using a user terminal or other imaging devices, or images transmitted or contributed by the user through an e-mail or a social networking service (SNS). It is preferable that the behavior information is information (first information) obtained by acquiring two or more types of information among the above-mentioned time information, position information, biological information, registration information and imaging information to be associated with each other. Here, the “associated” means that conditions that the behavior information is acquired are associated with each other, like “a certain point in time and a position at the point in time”.

As described later in detail, in this embodiment, behavior patterns of users are analyzed on the basis of the above-mentioned behavior information, and the behavior information is shared between the users.

The above-mentioned information is an example of the behavior information, and the behavior information may include different information. Further, instead of the entirety of the above-mentioned behavior information, a part of the information may be used.

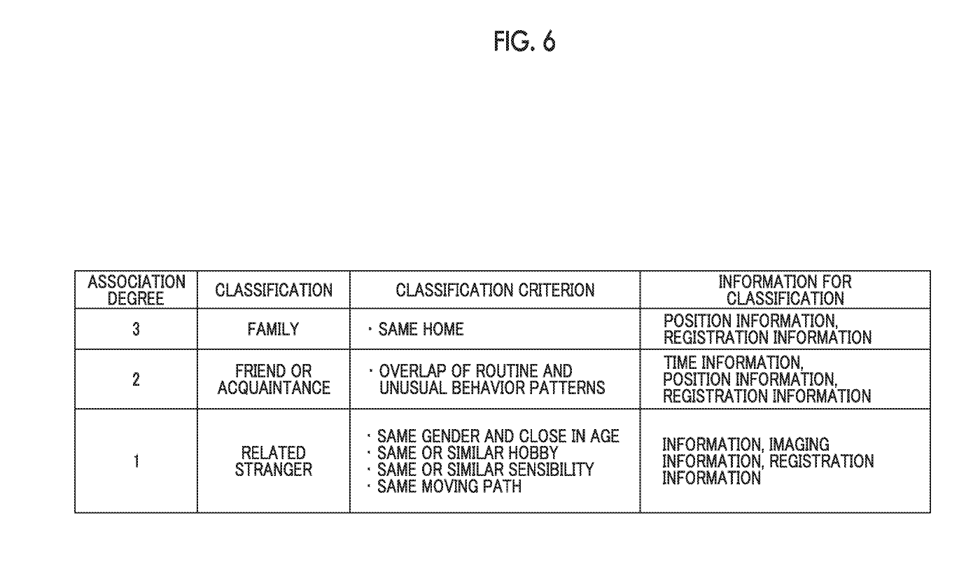

FIG. 6 is a table showing classification of users based on behavior information and examples of the degree of association corresponding to classification results. In the example of FIG. 6, the degree of association is classified into three stages of 1 (lowest) to 3 (highest), which respectively correspond to “associated others”, “friends or acquaintances”, and “family”. As a criterion for the classification, “same gender or similar hobbies”, “overlap of routine and unusual behavior patterns”, and “same home” may be used. Further, as shown in FIG. 6, the classification may be performed on the basis of behavior information (in this embodiment, time information, position information, biological information, and registration information). In this embodiment, the server 100 analyzes users' behavior information, and calculates the degree of association between users with reference to the relationship shown in FIG. 6 (step S104 in FIGS. 4 and 5: association degree calculation process).

Returning to FIGS. 4 and 5, the processing procedure of the information presentation method will be described. The user terminal 302 (user 1) transmits an acquisition request of behavior information of other users to the server 100 (step S106), and the server 100 receives the acquisition request (step S108: acquisition request reception process). The transmission of the acquisition request from the user terminal 302 may be performed according to an operation of the user terminal 302 from the user 1, or may be performed at a preset time interval. Further, in a case where the behavior information of the user 1 satisfies a certain condition (for example, in a case where the behavior information corresponds to one of “modes” to be described later), the acquisition request may be automatically transmitted.

In a case where the acquisition request is received in step S108, the server 100 determines which behavior information is to be requested with respect to the other users on the basis of the behavior information of the user 1 at a time when the acquisition request is received (step S110: request information determination process). The process of step S110 may be performed with reference to a relationship (see FIG. 12) between a “mode” (a situation of the user 1, that is, a “current” behavior) of the user 1 at the time when the acquisition request is received and the behavior information to be requested with respect to the other users, which is stored in advance in the relationship storage section 110 (see FIG. 2).

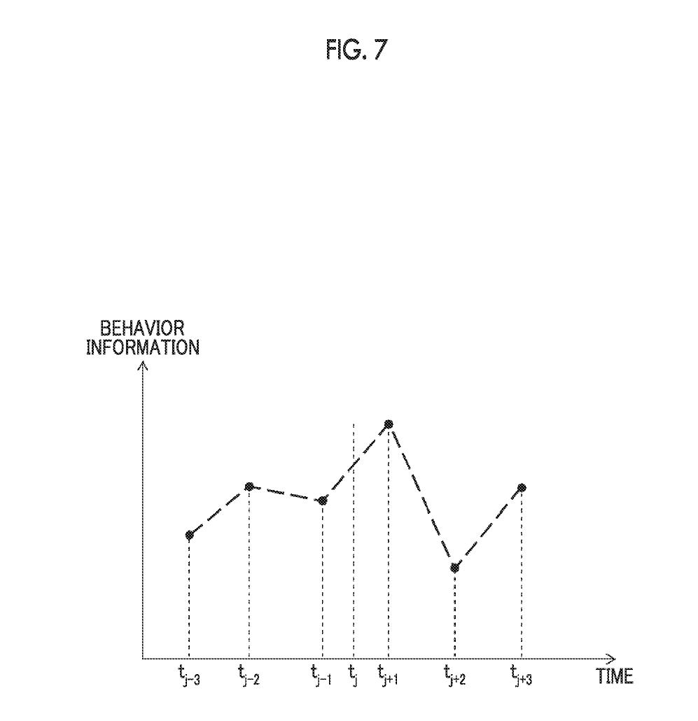

In this embodiment, it is assumed that “the behavior information of the user 1 “at the time when” the acquisition request is received” includes behavior information in a case where a timing when the acquisition request is received and a timing when the behavior information of the user 1 is acquired do not completely match each other. That is, the timing when the acquisition request is received and the timing when the behavior information of the user 1 is acquired may deviate from each other in a range where there is no influence on content of the behavior information (a range where a temporal change of the behavior information is allowable in view of properties of the information). Specifically, as shown in FIG. 7, in a case where the timing when the acquisition request is received is a time point tⱼ, the behavior information to be requested may be determined on the basis of behavior information at a time point tⱼ₋₁ prior to the time point tⱼ, or may be determined on the basis of behavior information at a time point tⱼ₊₁ later than the time point tⱼ. In a case where the behavior information to be presented to the user 1 is determined on the basis of the behavior information at the time point tⱼ₊₁ later than the time point tⱼ, the user terminal 302 acquires behavior information after the acquisition request, and transmits the result to the server 100 (step S107 in FIGS. 4 and 5).

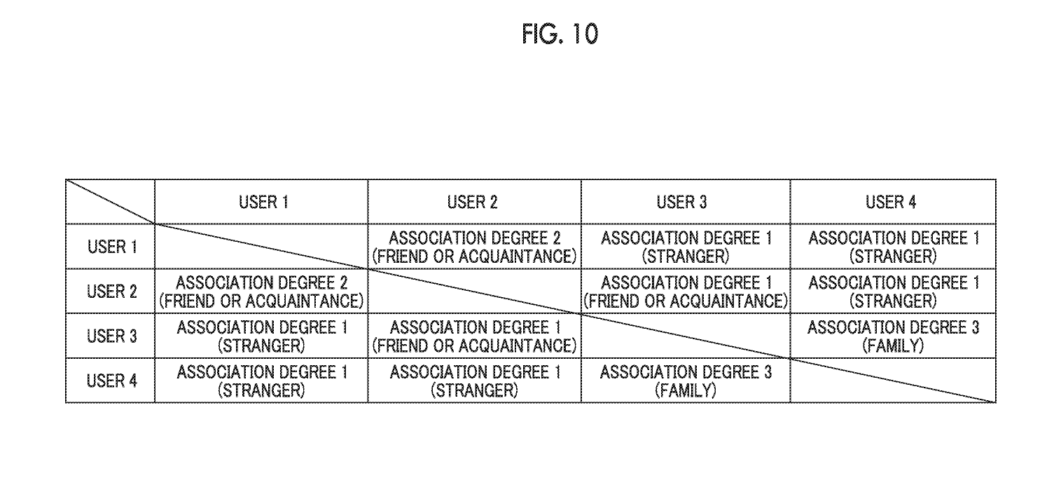

Then, the server 100 determines which user's behavior information is to be presented to the user 1 (step S112: user determination process). The determination of which user's behavior information is to be presented may be performed on the basis of the relationship shown in FIG. 10 and the degree of association (see FIG. 6) calculated in step S104. In FIGS. 4 and 5, for ease of description, a case where the behavior information of the user 2 is presented to the user 1 is shown, and a more specific example will be described later (see cases 1 to 3).

After the determination of which behavior information is to be requested and the determination of which user's behavior information is to be request are performed in the processes up to step S112, the server 100 requests information from the user terminal 304 of the user 2 according to the degree of association calculated as described above (step S113A: information request process), and acquires the information transmitted (step S113B) from the user terminal 304 according to the request. In a case where the behavior information of the user 2 is acquired to be presented to the user 1, when the behavior information of the user 2 already acquired at the time point when the acquisition request from the user 1 is received is present (step S108), the server 100 may present this acquired behavior information. For example, in the information presentation system, in a case where each user's behavior information is acquired continuously or at a predetermined interval, behavior information already acquired at the time point when the acquisition request from the user 1 is received may be presented. In this embodiment, it is assumed that both of a case where the behavior information acquired in step S113A and step S113B is presented and a case where the behavior information already acquired as described above is presented are included in a case where “the behavior information is requested with respect to the other users and the behavior information acquired according to the request is presented”.

After the behavior information of the user 2 is acquired in the processes up to step S113B, the server 100 transmits the determined behavior information to the user terminal 302 of the user 1 (step S114: information presentation process), and the user terminal 302 displays the received behavior information on the display 335 (step S116: information presentation process). In the information presentation processes of step S114 and step S116, a plurality of pieces of information selected from the time information, position information, biological information and imaging information of the user 2 are presented (displayed) in association. As an example of the “presentation of the plurality of pieces of information in association”, “a certain point in time (time information) and a position at the point in time (position information)” or “biological information at a certain location (position information)” may be used. A specific form of such information presentation will be described later (see cases 1 to 3). The information presentation may be performed by voice output through the speaker 333, instead of display on the display 335.

<Information Presentation to Other Users>

On the other hand, in a case where there is a behavior information acquisition request (step S118) from the user 2, similarly to the processes (steps S106 to S116) with respect to the request from the user 1, the server 100 determines which behavior information is to be requested and which user the request is given to through acquisition request reception (step S119: acquisition request reception process), request information determination (step S120: request information determination process), and user determination (step S120A: user determination process), requests information from the user terminal 302 (step S113A: information request process), acquires behavior information transmitted (step S113B: information transmission process) by the user terminal 302 according to the request, and transmits the acquired behavior information to the user terminal 304 (step S122: information presentation process). Then, the user terminal 304 displays the received behavior information (step S124: information presentation process). Here, similarly to the above description with respect to the user 1, in a case where there is behavior information of the user 1 already acquired at a time point when the acquisition request from the user 2 is received (step S119), the server 100 may present the behavior information already acquired as described above to the user terminal 304. In this case, as the degree of association, the degree of association calculated in step S104 (association degree calculation process) may be used.

In the information presentation system 10 according to this embodiment as described above, users may mutually (bi-directionally) share behavior information. In FIGS. 4 and 5, for ease of description, the behavior information acquisition request from the user 1 and the processes thereof (steps S106 to S116) have been preferentially handled prior to the behavior information acquisition request from the user 2 and the processes thereof (steps S118 to S124), but the handling order is not particularly limited, and thus, the behavior information acquisition request from any user may be preferentially handled.

<Specific Form of Information Presentation>

Next, a specific form of information presentation based on the above-described configuration and processing procedure will be described.

<Case 1>

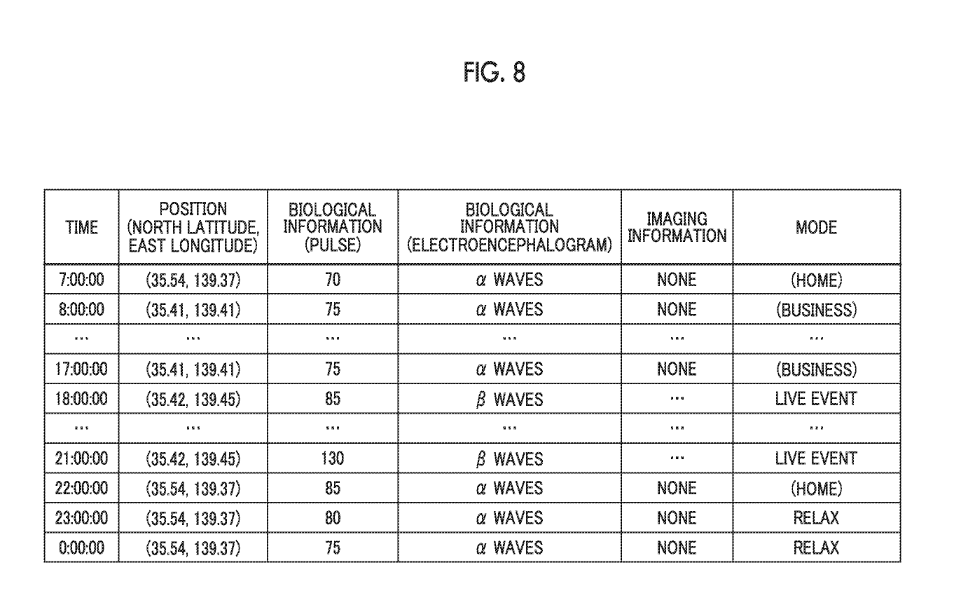

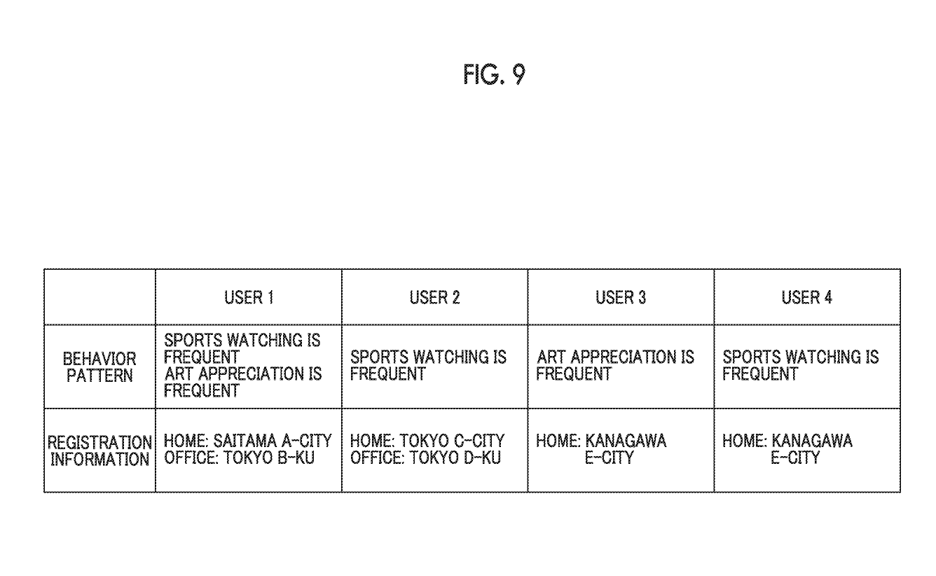

In a case 1, it is assumed that the user 1 (first user) acquires behavior information using the user terminal 302 as shown in FIG. 8. Specifically, position information (north latitude and east longitude), biological information (pulse and electroencephalogram), and imaging information (images) are acquired every hour and are transmitted to the server 100 through the network 200. That is, the position information, the biological information, and the imaging information are acquired in association with time information (in the example of FIG. 8, images are not acquired). The behavior information transmitted to the server 100 is stored in the behavior information storage section 108. In the case 1 and cases 2 and 3 (which will be described later), it is assumed that behavior information is similarly acquired with respect to other users (users 2 to 4 shown in FIGS. 9 and 10). A “mode” in the rightmost section of FIG. 8 will be described later.

The server 100 acquires behavior information as shown in the example of FIG. 8 over a certain considerably long period of time (for example, one month or longer) (behavior information acquisition process), and analyzes behavior patterns of respective users. As a result, in this case, it is assumed that behavior patterns of the users 1 to 4 are analyzed as shown in FIG. 9. Further, it is assumed that the users 1 to 4 register (registration information) locations of homes or offices, in addition to the above-described position information, biological information and imaging information, as behavior information using respective user terminals (the user terminals 302, 304, 306, and 308 shown in FIG. 1).

The server 100 calculates the degree of association between the users with reference to the relationship shown in FIG. 6, according to commonalities of behavior patterns (behavior information) of the respective users as shown in FIG. 9 (association degree calculation process). In this case, a weight for a commonality of specific information (for example, registration information relating to a home position or a family relation) may be set to be higher than weights for commonalities of different information. The degree of association between the users in the case 1 calculated as described above is shown in FIG. 10. In this way, by calculating the degree of association between users according to commonalities of behavior information of the users, each user can save labor for reporting the degree of association in person, and can easily share the behavior information.

The server 100 stores facility information as shown in FIG. 11 (positions, names and classification of various facilities), in addition to the behavior information acquired from the users, in the facility information storage section 109. The server 100 may compare the facility information with position information acquired from a user terminal to recognize a facility (a baseball field, an art gallery, or the like) where the user is located.

Next, a process of determining other users' behavior information to be presented to a user will be described. This process is performed with reference to a relationship between user's behavior information and information of which an acquisition request is given to other users, as shown in FIG. 12 (request information determination process). This relationship may be stored in the relationship storage section 110 of the server 100.

In FIG. 12, three examples are shown as “modes” of users. These modes are specified by user's behavior information (time information, position information, and biological information) at a time when an information acquisition request (step S106 in FIGS. 4 and 5) is received (step S108). This information corresponds to a plurality of types of information (second information) that are acquired in association as in “a certain point in time, and a position and biological information at that point in time” or “biological information at a certain location”. For example, a “relax mode” represents a mode indicating a situation where a user is relaxing at home. “At night” (time information) may be set to a time after 9 PM, for example, and “at home” (position information) may be determined on the basis of user's position information and registration information (home location, see FIG. 9). Further, a criterion for determining whether a user is “relaxing” (biological information) may be set as “the pulse is 80 per minute or lower and an electroencephalogram indicates a waves (8 to 13 Hz)”.

In the case 1, by appropriately setting “the relationship between the user's behavior information and the information of which the acquisition request is given to the other users” shown in FIG. 12, it is possible to share useful information while protecting users' privacies. For example, it is possible to prevent acquisition and presentation of information that is not to be known to other users, or even in a case where the information is acquired and presented, it is possible to allow the acquisition and presentation in a state where content or accuracy of the information is limited. Further, such a condition may be set in consideration of the degree of association between users. For example, information in a wide range may be presented to family or close friends with high accuracy, but information in a limited range may be presented to other people with low accuracy. In a case where the accuracy of information is low, a time interval at which information is acquired and presented may be extended, or values of position information or biological information may be set to large values.

In the case of the above-described “relax mode”, with respect to a user who has made a request of information acquisition, “a moving path on that day, a feeling (pulse and electroencephalogram), and captured images” is requested with respect to other users, and the acquired information is presented to the user. A period of time for the information acquisition is that one day, a geographic range for the information acquisition is within a moving path on that day, and request target users for the information acquisition are “family” or “friends or acquaintances”. The request target users have a degree of association of 2 or greater, and in a case where a plurality of users having different degrees of association are present (for example, a user having a degree of association 2 or a user having a degree of association 3), behavior information may be preferentially requested with respect to a user having a higher degree of association. For example, in a case where a user does not capture an image (for example, in the case of the user 1 shown in FIG. 8), or in a case where acquisition is refused or limited, behavior information may not be acquired even in a case where the behavior information is requested.

A “live event mode” and an “art appreciation mode” other than the “relax mode” will not be specifically described, but may be specified in a similar way to the “relax mode”. Specific examples in these modes will be described in cases 2 and 3. FIG. 12 shows an example relating to classification of modes, a determination criterion, and the like. Other modes different from the modes shown in FIG. 12 may be set, and the modes may be determined on the basis of a criterion different from that shown in FIG. 12. Further, an acquisition request range of behavior information may be set to a range different from that shown in FIG. 12.

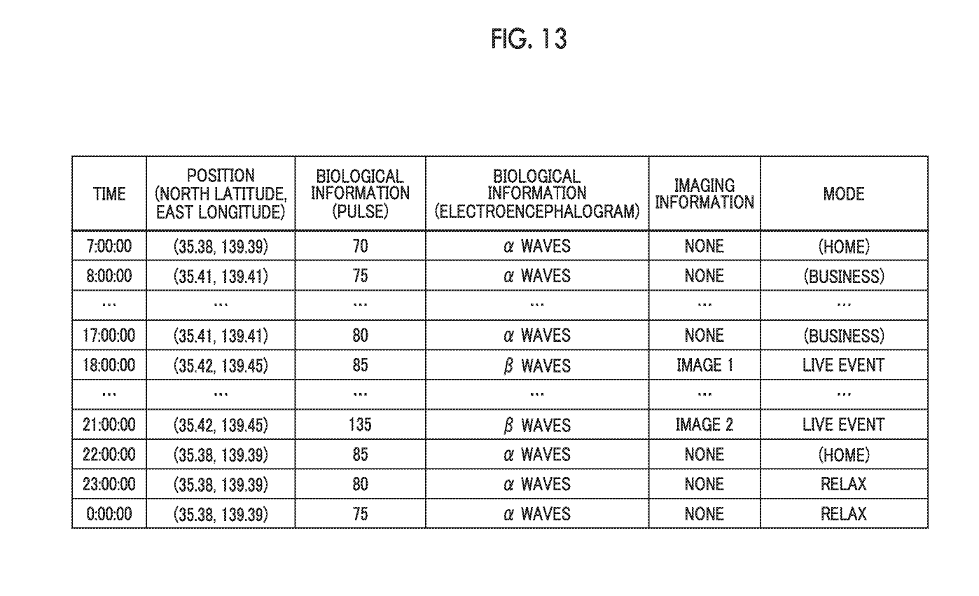

In the case 1, the behavior information of the user 1 is as shown in FIG. 8, and it is assumed that the behavior information acquisition request (see step S106 in FIG. 4) is transmitted from the user terminal 302 at 11 PM. In this case, referring to the relationship shown in FIG. 12, the user 1 is in the “relax mode”, and requests “a moving path on that day, a feeling (pulse and electroencephalogram), and captured images with respect to users having the degree of association 2 or greater (request information determination process). Since the degree of association between users in the case 1 is as shown in FIG. 10, “the user having the degree of association 2 or greater” is only the user 2 (friend or acquaintance of the user 1: a different user), and behavior information of the user 2 (information request process) is acquired and presented to the user 1 (information presentation process). It is assumed that the behavior information of the user 2 on that day is as shown in FIG. 13.

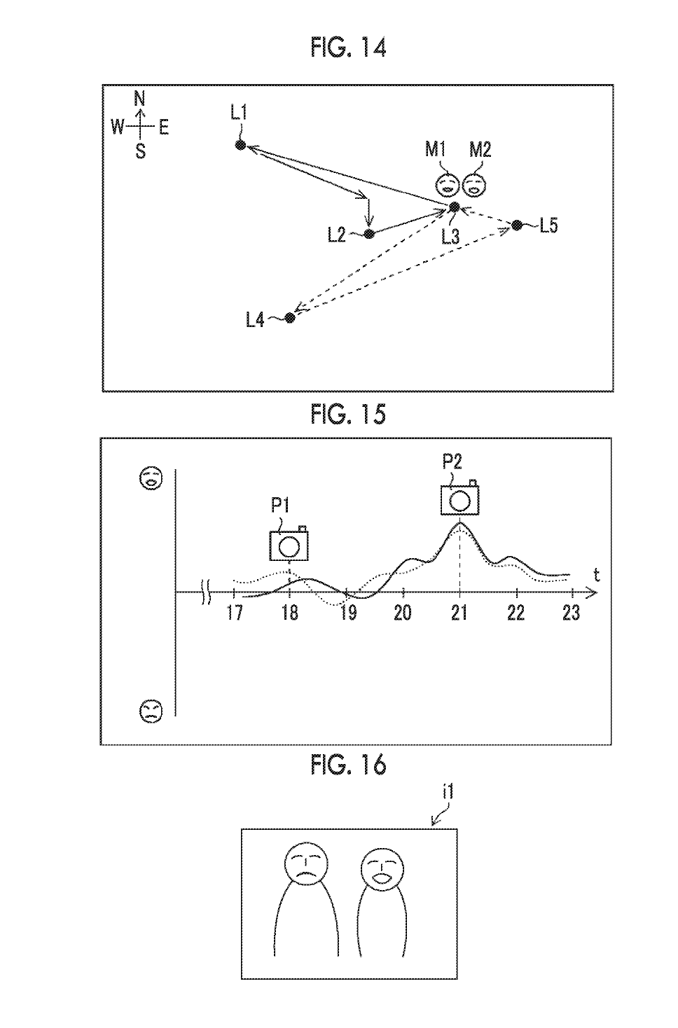

An example of the information presentation in the above-described case 1 will be described. FIG. 14 is a diagram showing an example of the information presentation to the user 1, in which a moving path of the user 2 on that day is indicated by dotted lines on a map (from a point L4 indicating home to a point L5 indicating an office, from the point L5 to a point L3 indicating a baseball field H, and from the point L3 to the point L4). The dotted lines present time information and position information of the user 2 in association. Further, the point L3 is indicated by a mark M2 indicating a feeling (pleasure; biological information) of the user 2 at the baseball field H. The mark M2 presents the position information and the biological information of the user 2 in association. The feeling of the user 2 is estimated by pulse and electroencephalogram acquired by the wrist wearing part and the head mounting part (see FIG. 3) provided in the user terminal 304.

In the example of FIG. 14, behavior information of the user 1 corresponding to the behavior information of the user 2 is also displayed. Specifically, a moving path of the user 1 on that day is indicated by solid lines on the map (from a point L1 indicating home to a point L2 indicating an office, from the point L2 to the point L3 indicating the baseball field H, and from the point L3 to the point L1). The solid lines present time information and position information of the user 1 in association. Further, the point L3 is indicated by a mark M1 indicating a feeling (pleasure; biological information) of the user 1 in the baseball field H. The mark M1 presents the position information of the user 1 and the biological information in association.

The behavior information presented as shown in FIG. 14 is displayed on the user terminal 302 of the user 1 and the user terminal 304 of the user 2 (information transmission process and information presentation process), and the user 1 and the user 2 may bi-directionally share the behavior information. Since the behavior information is acquired and presented according to a mode of the user 1, the users 1 and 2 may easily share the information.

FIG. 15 is a diagram showing another example of information presentation. In FIG. 14, temporal changes of feelings (biological information) of the user 1 and the user 2 are indicated by solid lines and dotted lines, respectively. That is, with respect to the user 1 and the user 2, biological information is presented in association with time information. Further, FIG. 15 shows an example in a case where the feelings of the users 1 and 2 are changed due to progression of a game in the baseball field H and reach a peak of pleasure at the end of the game (about 9 PM). In the example of FIG. 15, it is determined whether the feelings of the users 1 and 2 are pleasant (upper side in FIG. 15) or angry (lower side in FIG. 15) on the basis of the pulse and electroencephalogram acquired by the wrist wearing part and the head mounting part (see FIG. 3) provided in the user terminals 302 and 304, similarly to the example of FIG. 14.

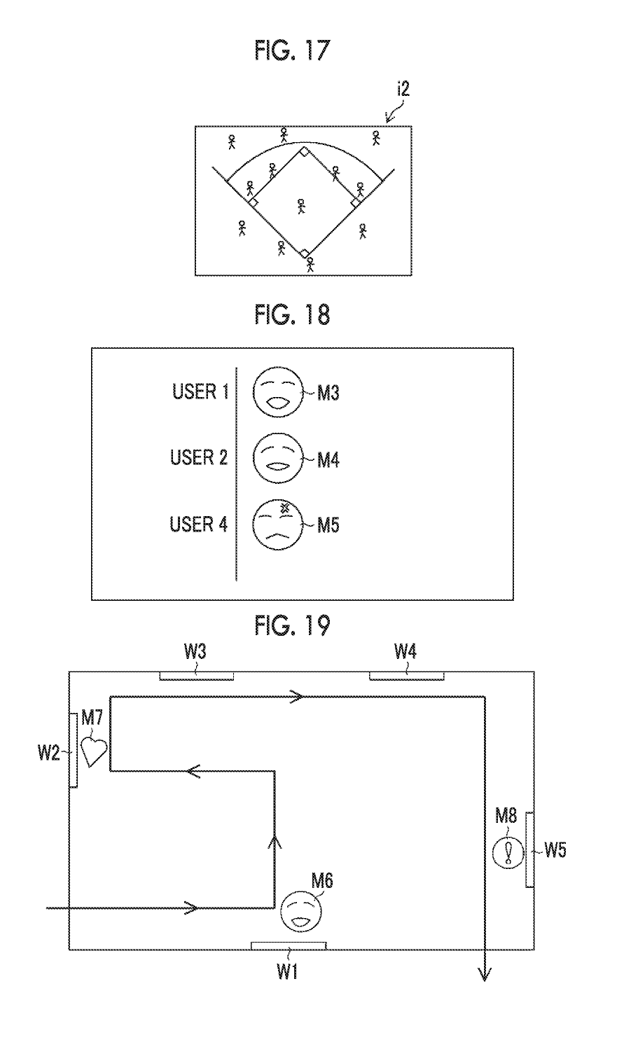

In FIG. 15, marks P1 and P2 of a camera displayed at 6 PM and 9 PM represent that images i1 and i2 captured by the user 2 at those times are present. In a case where the user 1 or the user 2 designates the respective marks P1 and P2 on the user terminal 302 or 304 (through selection using buttons, tapping using a touch panel, or the like), as shown in FIGS. 16 and 17, the images i1 and i2 are displayed on a display. The behavior information presented as shown in FIGS. 15 to 17 is displayed on the user terminal 302 of the user 1 and the user terminal 304 of the user 2, similarly to the example of FIG. 14, and the user 1 and the user 2 may bi-directionally share the behavior information.

In this way, in the case 1, the user 1 and the user 2 can share memories (information) indicating that “I enjoyed watching the baseball game with a friend of mine, today” looking back on that one day. That is, the users can easily share useful information.

<Case 2>

Next, information presentation in a case where a user's situation is the “live event mode” (see FIG. 12) will be described. In this case 2, it is assumed that the user 1 (first user) transmits a behavior information acquisition request (see step S106 in FIGS. 4 and 5) during watching the baseball game (from 6 PM to 9 PM) at the baseball field H, in the same situation as in case 1. As shown in FIG. 11, in the “live event mode”, current behavior information of a person having a degree of association 1 or greater (at a time when the server 100 receives the acquisition request) in “the vicinity of a current location (the same venue)” is acquired and is presented to the user 1. In the case 2, similarly to the above description with respect to the case 1, with reference to the behavior patterns of the respective users shown in FIG. 8 and the degrees of association between the users shown in FIG. 9, the user 2 (“friend or acquaintance” with respect to the user 1: second user) and the user 4 (“related stranger” for the user 1: different user) are extracted. The user 3 has a degree of association 1, but since the user 3 does not have a common behavior pattern with the user 1 as shown in FIG. 8, behavior information of the user 3 is not extracted. By acquiring position information through the user terminal 308 (see FIG. 1) of the user 4, it is possible to confirm that the user 4 is at the baseball field H at that time.

FIG. 18 is a diagram showing an example of information to be presented to a user in the case 2. In the example of FIG. 18, current feelings of the users 1, 2, and 4 (the users 1 and 2 are pleasant and the user 4 is angry) are indicated by marks M3 to M5. In the example of FIG. 18, it may be estimated whether the feelings of the users 1, 2, and 4 are pleasant or angry on the basis of pulse and electroencephalogram acquired by the wrist wearing part 316 and the head mounting part 312 (see FIG. 3) provided in the user terminal 302, 304, and 308, similarly to the examples shown in FIGS. 14 and 15. In addition to the marks M3 to M5, different marks may be used according to levels of pleasure or anger of the users.

The information as shown in FIG. 18 is similarly presented to the user terminals 302, 304, and 308 (see FIG. 1) of the users 1, 2, and 4, and the users may bi-directionally share the information. For example, the user 1 may enjoy imagination such as “The user 4 is angry. Does it seem that a team that the user 4 supports is losing the game?” while looking at the information. In this way, in the case 2, the user 1 can also share behavior information (biological information indicating a feeling during watching the baseball game) with the user 4 who is “a stranger having a related behavior pattern” as well as the user 2 (friend or acquaintance), and the users can easily share useful information.

In the case 2, similarly to the case 1, by appropriately setting “the relationship between the user's behavior information and the information of which the acquisition request is given to the other users” shown in FIG. 12, it is possible to share useful information while protecting users' privacies.

<Case 3>

In the above-described “live event mode” of the case 2, behavior information of a person who is currently nearby (at a time when an information acquisition request is received) is presented to a user, but in the case 3, a case where “even a person who is not currently in the location becomes a behavior information acquisition target” will be described. Specifically, in the case 3, when the user 1 (first user) visits an art gallery J (see FIG. 10) and is a state of an “art appreciation mode” (pulse of 85 or lower and electroencephalogram of α waves), it is assumed that a behavior information acquisition request is transmitted to the server 100 through the user terminal 302 (see step S106 in FIG. 4).

Referring to the relationship shown in FIG. 11, acquisition request targets are users having a degree of association 1 or greater, and correspond to the users 2 to 4 in a situation shown in FIG. 9, but with reference to the behavior patterns of the respective users shown in FIG. 8, behavior information of the user 3 (“related stranger” for the user 1: different user) who is common to the user 1 in a behavior indicating that “art appreciation is frequent” is acquired and presented. In this case, it is not essential that the user 3 is in the art gallery J at the same time with the user 1, and even in a case where the user 3 visited the art gallery J in the past, behavior information (a moving path, locations where highly rated works are present, feelings in appreciation of such works, or the like) at that time may be acquired.

FIG. 19 shows an example in which the behavior information of the user 3 at the art gallery J (shown in a plan view) acquired as described above is displayed on the user terminal 302 of the user 1. Specifically, a moving path (position information; an arrow direction in FIG. 19) of the user 3 in the art gallery J and feelings (biological information) in appreciation of respective works are displayed in association, and marks M6 to M8 indicating feelings of the user are shown at positions of works W1, W2, and W5. By viewing the information presented in this way, the user 1 can know the moving path of the user 3, the locations where highly rated works are present, and the feelings of the user 3 in appreciation of the works. Thus, with reference to the above-mentioned information, the user 1 can take an action while enjoying imagination such as “I am going to slowly appreciate the work W1 and the work W2 because the work W1 seems like an interesting work and the work W2 seems like a romantic work. I am going to skip the work W3 and the work W4 because the works have no mark and do not seem like interesting works. The work W5 is worthy of attention.”, for example.

As described above, in the case 3, the user 1 can easily share useful information (locations where highly rated works are present, and feelings in appreciation of the works) even with the user 3 who is “a stranger having a related behavior pattern” and is “a person who is not in the location at the moment”. In the case 3, similarly to the cases 1 and 2, the behavior information (a moving path of the user 1 in the art gallery J, locations where highly rated works are present, feelings in appreciation of the works, or the like) of the user 1 corresponding to the behavior information of the user 3 may be presented to the user 3.

In the case 3, similarly to the cases 1 and 2, by appropriately setting “the relationship between the user's behavior information and the information of which the acquisition request is given to the other users” shown in FIG. 12, it is possible to share useful information while protecting users' privacies.

As described above, according to the information presentation apparatus, the information presentation method, and the information presentation program according to the invention, users can easily share useful information.

The invention is not limited to the above-described embodiments, and various modifications may be made in a range without departing from the concept of the invention. For example, a user terminal is not limited to the configuration shown in FIG. 3, and may be configured by a part of a terminal body, a wrist wearing part, and a head mounting part (a configuration in which the wrist wearing part has all the functions, for example), or may be configured by a terminal to be mounted in another portion (the arms, the feet, the legs, the chest, or the like) of the user.

Further, as behavior information, information other than the above-described information may be used. For example, it may be considered that information on sweating, breathing, or voice is acquired as biological information. Further, feelings may be classified into pleasure, anger, love, amusement, and other feelings, and in estimation of the feelings, biological information on the above-mentioned sweating, breathing, voice, or the like may be used, instead of pulse and electroencephalogram. Further, in addition to imaging information relating to images, text information transmitted or received using an e-mail, SNS, or the like may be used as behavior information.

In addition, in the above-described cases 1 to 3, the user association degree is divided into three stages, but may be divided into four or more stages. For example, “friends or acquaintances” may be divided into “close friends or acquaintances” and “general friends or acquaintances”, and the degree of association for another classification item such as “colleagues” may be set. With respect to user's “modes”, other modes such as “traveling”, “home”, or “business” in addition to the modes shown in FIG. 12 may be defined. Further, in the above-described cases 1 to 3, for ease of description, a case where the number of users is a few, that is, four has been described, but behavior information of a large number of users may be acquired and presented. In a case where the behavior information of a large number of users is presented, statistically processed results may be used.

### EXPLANATION OF REFERENCES

1: user

2: user

3: user

4: user

10: information presentation system

100: server

102: communication section

104: controller

104B: ROM

106: processing section

108: behavior information storage section

109: facility information storage section

110: relationship storage section

200: network

300: user terminal

302: user terminal

304: user terminal

306: user terminal

308: user terminal

310: terminal body

312: head mounting part

314: antenna

316: wrist wearing part

318: antenna

322: bus

323: ROM

324: RAM

325: controller

327: storage section

328: operating section

331: microphone

333: speaker

334: voice processing section

335: display

336: image processing section

337: wireless communication section

338: antenna

341: imaging section

342: image processing section

343: position measurement section

344: antenna

M1: mark

M2: mark

M3: mark

M4: mark

M5: mark

M6: mark

M7: mark

M8: mark

P1: mark

P2: mark

S100 to S124: respective steps of information presentation method

W1: work

W2: work

W3: work

W4: work

W5: work

i1: image

i2: image

What is claimed is:

1. An information presentation method using a computer comprising:
a behavior information acquisition process of acquiring behavior information of users;
an association degree calculation process of calculating, on the basis of the behavior information of a first user and the behavior information of a different user, a degree of association between the first user and the different user;
an acquisition request reception process of receiving an acquisition request of the behavior information with respect to the different user from the first user;
a request information determination process of determining information to be requested with respect to the different user from the first user, on the basis of the behavior information of the first user at a time when the acquisition request is received;
an information request process of requesting the behavior information with respect to the different user from the first user, the information request process requesting the determined behavior information according to the calculated degree of association; and
an information presentation process of presenting the behavior information of the different user that is acquired according to the request to the first user.

2. The information presentation method using the computer according to claim 1,
wherein in the request information determination process, the behavior information to be requested with respect to the different user is determined with reference to a relationship between the behavior information of the first user at the time when the acquisition request is received and the behavior information to be requested with respect to the different user, which is stored in advance.

3. The information presentation method using the computer according to claim 1,
wherein in the association degree calculation process, the degree of association is calculated according to a commonality of the behavior information.

4. The information presentation method using the computer according to claim 2,
wherein in the association degree calculation process, the degree of association is calculated according to a commonality of the behavior information.

5. The information presentation method using the computer according to claim 1,
wherein in the association degree calculation process, a weight for a commonality of specific information among information included in the behavior information is set to be higher than a weight for a commonality of different information to calculate the degree of association.

6. The information presentation method using the computer according to claim 2,
wherein in the association degree calculation process, a weight for a commonality of specific information among information included in the behavior information is set to be higher than a weight for a commonality of different information to calculate the degree of association.

7. The information presentation method using the computer according to claim 3,
wherein in the association degree calculation process, a weight for a commonality of specific information among information included in the behavior information is set to be higher than a weight for a commonality of different information to calculate the degree of association.

8. The information presentation method using the computer according to claim 1, further comprising:
an information transmission process of presenting the behavior information of the first user to the different user according to an information acquisition request from the different user.

9. The information presentation method using the computer according to claim 2, further comprising:
an information transmission process of presenting the behavior information of the first user to the different user according to an information acquisition request from the different user.

10. The information presentation method using the computer according to claim 3, further comprising:
an information transmission process of presenting the behavior information of the first user to the different user according to an information acquisition request from the different user.

11. The information presentation method using the computer according to claim 8,
wherein in the information transmission process, the behavior information of the first user corresponding to the behavior information of the different user presented to the first user is presented to the different user.

12. The information presentation method using the computer according to claim 1,
wherein the behavior information includes first information that is information acquired by association of one type of information and a different type of information that are two or more types of information among time information, position information, biological information, and imaging information of the users.

13. The information presentation method using the computer according to claim 2,
wherein the behavior information includes first information that is information acquired by association of one type of information and a different type of information that are two or more types of information among time information, position information, biological information, and imaging information of the users.

14. The information presentation method using the computer according to claim 1,
wherein in the request information determination process, the information to be requested with respect to the different user is determined on the basis of second information that is information acquired by association of one type of information and a different type of information that are two or more types of information among time information, position information, and biological information of the users.

15. The information presentation method using the computer according to claim 1,
wherein in the information presentation process, a plurality of types of information selected from time information, position information, biological information, and imaging information of the users are presented in association.

16. A non-transitory computer readable recording medium storing an information presentation program for causing an information presentation apparatus to execute the information presentation method according to claim 1.

17. An information presentation apparatus comprising:
a behavior information acquisition section that acquires behavior information of users;
an association degree calculation section that calculates, on the basis of the behavior information of a first user and the behavior information of a different user, a degree of association between the first user and the different user;
an acquisition request reception section that receives an acquisition request of the behavior information with respect to the different user from the first user;
a request information determination section that determines information to be requested with respect to the different user from the first user, on the basis of the behavior information of the first user at a time when the acquisition request is received;
an information request section that requests the behavior information with respect to the different user from the first user, the information request section requesting the determined behavior information according to the calculated degree of association; and
an information presentation section that presents the behavior information of the different user that is acquired according to the request to the first user.

18. The information presentation apparatus according to claim 17, further comprising:
a relationship storage section that stores in advance a relationship between the behavior information of the first user at the time when the acquisition request is received and the behavior information to be requested with respect to the different user,
wherein the request information determination section determines the behavior information to be requested with respect to the different user with reference to the stored relationship.

19. The information presentation apparatus according to claim 17, further comprising:
an information transmission section that presents the behavior information of the first user to the different user according to an information acquisition request from the different user.

20. The information presentation apparatus according to claim 19,
wherein the information transmission section presents the behavior information of the first user corresponding to the behavior information of the different user presented to the first user to the different user.
